(19) United States
(12) Patent Application Publication
(10) Pub. No.: US 2020/0265430 A1
(43) Pub. Date: Aug. 20, 2020

(54) METHOD AND SYSTEM FOR AUTOMATED MANAGEMENT OF CREDIT AND GRANT ALLOCATION

(71) Applicant: MASTERCARD INTERNATIONAL INCORPORATED, Purchase, NY (US)

(72) Inventors: David A. Sadlier, Dublin 16 (IE); Nagesh Pulluru, Clonee (IE); Mark O'Looney, Dublin 18 (IE); Stephen Ward, Greystones (IE); Eion Flood, Dublin (IE)

(73) Assignee: MASTERCARD INTERNATIONAL INCORPORATED, Purchase, NY (US)

(21) Appl. No.: 16/278,338

(22) Filed: Feb. 18, 2019

(51) Int. Cl. G06Q 20/40

(52) U.S. Cl. CPC G06Q 20/405

(57) ABSTRACT

A method for evaluating adherence to funding rules includes: storing transaction data entries, each including a controlled payment number (CPN), a merchant category code, transaction date, and transaction data, where the CPN is subject to a first spend control setting a maximum spend amount during a predetermined time interval; identifying a group of transaction data entries that includes a transaction date within a predetermined period of time; identifying a subset of the group of transaction data entries where the merchant category code is one of a set indicated in a funding adherence rule; determining an adherence score for the CPN based on a ratio of a number of transaction data entries in the subset to a number of transaction data entries in the group; and modifying the first spend control to adjust the maximum spend amount based on the adherence score and funding adherence rule.

### FIELD

The present disclosure relates to a computer implementation for evaluating adherence to funding rules, specifically the use of controlled payment numbers and spend controls to ensure adherence to one or more funding rules based on transactional activity, such as may be used in grant funding or other fund allocations.

### BACKGROUND

Charitable organizations and other entities often operate by providing funds to recipients, employees, or others as part of the mission or objective of the entity. In many cases, the funding comes with an expectation for how the funds should be used. For example, a charitable organization focused on providing food to needy families may expect that any donated funds are used for purchasing food and not misused by the recipient. In such cases, the ability to enforce such restrictions may be greatly limited. Any direct cash or credit that is provided to the recipient cannot be controlled, and thus is subject to solely to the whims of the recipient. As such, some entities may provide the recipient with credit at specific merchants, where the merchant may only sell the goods that the entity approves purchase of, or where the entity may have a deal with the merchant to enable the credit to only be used on approved items. However, such methods require entities to enter into agreements with merchants, which can be difficult and time consuming, and are also extremely limiting on recipients.

An alternative solution that has been used by some charitable organizations involves the use of controlled payment numbers. Controlled payment numbers, defined in greater detail below, are numbers associated with a transaction account that are subject to one or more spend controls, such as a limit on what merchant categories the controlled payment number can be used at or how much may be used in any individual transaction. Controlled payment numbers thus provide these entities with the ability to provide funding to a recipient that can only be used at approved merchants and for a set amount, but without requiring individual dealings with each merchant.

However, management of controlled payment numbers can be a cumbersome and difficult process, particularly for entities that provide funding to a significant number of recipients. In such cases, the organization must monitor the transactions for each recipient and manually make any needed adjustments, such as to accommodate necessary changes in acceptable merchants, funding amounts, etc. These types of adjustments may become exceedingly difficult if each recipient is managed on a case-by-case basis, or if there is a need to adjust controls entity-wide as the controls must be adjusted for every recipient, which can be laborious for entities with thousands, or sometimes millions, of recipients.

Thus, there is a need for a technical solution where management of controlled payment numbers for an entity can be automated on a basis different than used in a manual process. Specifically, there is a need to improve existing technical systems to enable entities to manage controlled payment numbers for funding recipients indirectly to reduce need for managerial oversight and increase operating efficiency.

### SUMMARY

The present disclosure provides a description of systems and methods for evaluating adherence to funding rules. Funding rules are set by an entity that provides funding to recipients, such as a charitable organization that sets restrictions on how its distributed charitable funds can be used. The funding rules are set by the entity the processing system can evaluate the transaction history of a recipient to determine how well the recipient has adhered to the funding rules, representing such a metric with an adherence score. The adherence score is then used to adjust the funding for that recipient as set by the entity, which may have rules set forth for adjustments that apply to all recipients, individual recipients, or somewhere in between (e.g., specific classes or categories of recipients). Adjustments to funding are made through modifications of spend controls on controlled payment numbers that are issued to recipients, resulting in the processing system having automated adjustments to recipient funding based on their ability to adhere to the rules set forth by the entity. As a result, the entity can manage funding for all recipients through simply adjusting their adherence rules and funding rules, where any changes are automatically propagated through all relevant recipients by the processing system.

A method for evaluating adherence to funding rules includes: storing, in a transaction database of a processing server, a plurality of transaction data entries, wherein each transaction data entry includes data related to a payment transaction including at least a controlled payment number, one of a plurality of merchant category codes, transaction date, and transaction data, where the controlled payment number is subject to at least one spend control including a first spend control setting a maximum spend amount during a predetermined time interval; identifying, by a processing device of the processing server, a group of the plurality of transaction data entries, wherein each transaction data entry in the group includes a transaction date within a predetermined period of time; identifying, by the processing device of the processing server, a subset of the group of transaction data entries, wherein each transaction data entry in the subset includes a merchant category code of a set of merchant category codes indicated in a funding adherence rule associated with the controlled payment number; determining, by the processing device of the processing server, an adherence score for the controlled payment number, wherein the adherence score is based on at least a ratio of a number of transaction data entries in the subset of transaction data entries to a number of transaction data entries in the group of transaction data entries; and modifying, by the processing device of the processing server, the first spend control to adjust the maximum spend amount based on the determined adherence score and the funding adherence rule.

A system for evaluating adherence to funding rules includes: a transaction database of a processing server configured to store a plurality of transaction data entries, wherein each transaction data entry includes data related to a payment transaction including at least a controlled payment number, one of a plurality of merchant category codes, transaction date, and transaction data, where the controlled payment number is subject to at least one spend control including a first spend control setting a maximum spend amount during a predetermined time interval; and a processing device of the processing server configured to identify a group of the plurality of transaction data entries, wherein each transaction data entry in the group includes a transaction date within a predetermined period of time, identify a subset of the group of transaction data entries, wherein each transaction data entry in the subset includes a merchant category code of a set of merchant category codes indicated in a funding adherence rule associated with the controlled payment number, determine an adherence score for the controlled payment number, wherein the adherence score is based on at least a ratio of a number of transaction data entries in the subset of transaction data entries to a number of transaction data entries in the group of transaction data entries, and modify the first spend control to adjust the maximum spend amount based on the determined adherence score and the funding adherence rule.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for evaluating adherence to funding rules in accordance with exemplary embodiments.

FIG. 2 is a block diagram illustrating the processing server of the system of FIG. 1 for evaluating adherence to funding rules in accordance with exemplary embodiments.

FIG. 3 is a flow diagram illustrating a process for adjusting recipient funding for a charitable organization based on adherence to funding rules executed by the processing server of FIG. 2 in accordance with exemplary embodiments.

FIG. 4 is a flow chart illustrating an exemplary method for evaluating adherence to funding rules in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. Pat. No. 7,359,880, issued Apr. 15, 2008; U.S. Pat. No. 7,895,122, issued Feb. 22, 2011; U.S. Pat. No. 8,229,854, issued Jul. 27, 2012; U.S. Pat. No. 8,321,315, issued Nov. 27, 2012; U.S. Pat. No. 8,510,218, issued Aug. 13, 2013; U.S. Pat. No. 8,639,623, issued Dec. 27, 2012; U.S. Pat. No. 8,756,150, issued Jun. 17, 2014; and U.S. Pat. No. 8,527,416, issued Sep. 3, 2013, each of which are herein incorporated by reference in their entirety.

System for Evaluation of Adherence to Funding Rules

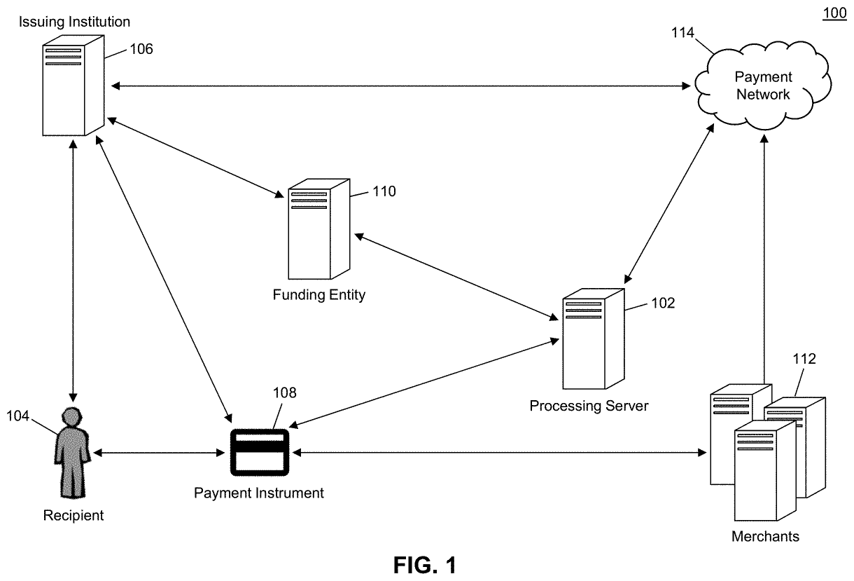

FIG. 1 illustrates a system 100 for the evaluation of adherence of a funding recipient to funding rules set by the funding agency on use of the funds, and the automated adjustment of spend controls related thereto based on the adherence.

The system 100 may include a processing server 102. The processing server 102, discussed in more detail below, may be configured to evaluate adherence to funding rules by a recipient 104 that has received funds from a funding entity 110. In the system 100, an issuing institution 106 may issue a transaction account to the funding entity 110 that may be used to fund electronic payment transactions. The issuing institution 106 may be a financial institution, such as an issuing bank, or other entity configured to issue transaction accounts. The funding entity 110 may be an entity that distributes funds to recipients 104 for use in funding payment transactions that are subject to rules set by the funding entity 110. For example, the funding entity 110 may be a charitable organization that distributes funds to recipients 104 for charity, an employer that distributes funds to employees for purchasing goods or services for work, a parent that is providing an allowance to a child, etc.

The transaction account issued to the funding entity 110 may be configured for usage with controlled payment numbers (CPNs). CPNs may be issued on the transaction account that are processed similar to real account numbers, but where any payment transaction attempted using the CPN is subject to one or more spend controls associated with the CPN. If the attempted payment transaction complies with the applicable spend controls, then the payment transaction is processed and funded by the underlying transaction account. In this manner, the funding entity 110 may issue a CPN on the same transaction account to a plurality of different recipients 104, where each recipient 104 may receive a different CPN, but all of which will fund transactions using the same underlying transaction account. As part of the issuing of CPNs to recipients 104, the funding entity 110 may set spend controls for each of the CPNs.

Spend controls may be limits on the usage of the CPN to fund payment transactions. Spend controls may be applicable on a per-transaction basis and/or may apply to multiple transactions, such as over a predetermined number of transactions or for all transactions during a predetermined period of time. Spend controls can limit, for example, transaction amounts, number of transactions, transaction frequency, merchants, merchant categories, products, product categories, transaction times, transaction dates, geographic locations, etc. For instance, the funding entity 110 may set a spend control for the total amount spent during a month as well as a spend control on the merchant categories with which a recipient 104 may transact, which may facilitate monthly funding of a recipient 104 for specific types of purchases (e.g., $500 a month only on food). In the system 100, the funding entity 110 may set spend controls on an individual CPN level, for all CPNs issued on the transaction account, or based on groupings of CPNs. For instance, the funding entity 110 may have groups of recipients 104 where each grouping may have a common set of spend controls applied to the CPNs issued thereto.

As part of the system 100, the issuing institution 106 may issue a payment instrument 108 to the recipient 108 for use of the CPN. The payment instrument 108 may be a physical payment card, a virtual payment card, or other instrument used to convey the CPN and any other necessary payment credentials to a merchant 112 as part of an electronic payment transaction. The recipient 104 may present the payment instrument 108 to a merchant 112, which may read the CPN and any other payment credentials therefrom. The merchant 112 may submit a payment transaction for processing that is funded by the CPN by including the CPN and any other payment credentials in a transaction message that is submitted (e.g., directly or via one or more intermediate entities, such as an acquiring institution or gateway processor) to a payment network 114 for processing. The payment network 114 may receive a transaction message for the payment transaction (e.g., generated by the merchant 112 or an intermediate entity), where the transaction message is a specially formatted data message that is formatted according to one or more standards governing the interchange of financial transaction messages, such as the International Organization of Standardization's ISO 8583 or ISO 20022 standards.

The payment network 114 may receive the transaction message for the transaction and may process it using traditional methods and systems. As part of the processing, the transaction message may be routed to the issuing institution 106. The issuing institution 106 may identify that a CPN is used for the payment transaction (e.g., identifying it in a data element configured to store a primary account number for funding of the payment transaction) and may then identify the applicable spend controls. The issuing institution 106 may determine if the attempted transaction is in compliance with the spend controls that are set for that CPN. If the attempted transaction is in compliance, the issuing institution 106 may perform standard processing for approval or denial of the transaction. If the attempted transaction is not in compliance, the transaction may be denied. The approval or denial may be provided to the payment network 114 (e.g., in a transaction message), where the payment network 114 may inform the merchant 112 of the approval or denial (e.g., directly or via an intermediate entity). The merchant 112 may then finalize the payment transaction accordingly, such as by providing the recipient 104 with purchased goods or services if the transaction was approved. The funding entity 110 may thus control usage of funds by the recipient 104 using the spend controls.

In the system 100, the processing server 102 may be configured to evaluate the adherence of the recipient 104 to one or more funding rules set forth by the funding entity 110. This is a technically different approach than used in largely manual conventional systems. In some embodiments, the funding rules may be the same as the spend controls. In other embodiments, the funding rules may be separate from the spend controls, such as used to encourage, but not limit, usage of funds by the recipient 104. For example, the funding entity 110 may set a spend control limiting the recipient 104 to $500 per month without limiting the merchants where the money may be used, but have adherence rules requesting that at least $300 a month is spent at grocery stores. The processing server 102 may be configured to evaluate the compliance of recipients 104 with such adherence rules. As with spend controls, adherence rules may be set on a per-recipient basis, may be applicable to all recipients 104, or may be applicable to predetermined groups of recipients 104. In some cases, the processing server 102 may perform evaluations upon request by the funding entity 110. In other cases, the processing server 102 may perform evaluations periodically, such as matching a period corresponding to adherence rules and/or spend controls. For instance, if adherence rules specify amounts spent in a month, the processing server 102 may evaluate adherence at the end of each month.

To evaluate the adherence, the processing server 102 may identify all payment transactions funding using the CPN issued to the recipient 104 during the applicable period of time. In some embodiments, the processing server 102 may receive the transaction data from the issuing institution 106. In other embodiments, the processing server 102 may receive the transaction data from the funding entity 110 or from the payment network 114. The transaction data may be comprised of a plurality of transaction data entries, where each transaction data entry is related to a processed payment transaction and includes at least the CPN, a transaction date within the applicable period of time, and additional transaction data. The processing server 102 may then identify a subset of the transaction data entries that indicate adherence to applicable adherence rules, based on the adherence rule(s) and the data included in the additional transaction data. For instance, if the adherence rule is for spending at specific types of merchants, the transaction data entries in the subset may have merchant category codes that match the specific types of merchants. In another example, the subset may include payment transactions conducted in a specific geographic area.

Once the subset of transactions has been identified, the processing server 102 may determine an adherence score for the recipient 104. The adherence score may be a value representing the recipient's adherence to the applicable adherence rules, based on at least a ratio of the number of transaction data entries in the subset and the total number of transaction data entries for the applicable period of time. In some cases, the ratio may be based on an aggregation of transaction data for transactions in the subset and all transactions, such as in cases where the adherence rule is for a transaction amount. For example, if the adherence rule is that 80% of funding is used at grocery stores, the processing server 102 may total the transaction amounts for transaction data entries in the subset (e.g., with merchant category codes for grocery stores) compared to the total transaction spending of all transactions during the applicable period. In such an example, the adherence score would be based on if the ratio of grocery spending to total spending is at least 0.8 to match the 80% adherence rule. In some cases, the value of the adherence score may be based on further criteria set forth by the funding entity 110. For instance, one funding entity 110 may request that the adherence score scale linearly with how close the recipient 104 was to the adherence rule, while a second funding entity 110 may request a normal distribution across all recipients 104.

Once the adherence score is identified, the processing server 102 may initiate modification to the applicable spend controls for the CPN based on the adherence score. The modification to the spend controls may be based on additional rules or criteria set by the funding entity 110 for the recipient 104, all recipients, or a group that includes the recipient 104. For instance, each set of adherence rules may include accompanying rules regarding modification to the spend controls. In an example, the criteria may include a range where any adherence score that falls within the range results in maintaining current spend controls, an adherence score below the range results in a negative adjustment to spend controls (e.g., lowered aggregate spending amount), and an adherence score above the range results in a positive adjustment to spend controls (e.g., higher aggregate spending amount). For instance, a recipient 104 that is adhering to the funding entity's funding guidelines may have a higher spending limit or increased number of merchants where funding can be used, while a recipient 104 that is abusing the funding may have limits made more strict to enforce closer following of funding guidelines. The processing server 102 may continue to modify spend controls accordingly over multiple periods of time. In some cases, the funding entity 110 may set overall limits on how loose or strict spend controls may be outside of adherence rules or other criteria. In such cases, the processing server 102 may only modify the spend controls for recipients 104 within such limits.

In some embodiments, the processing server 102 may provide modifications of spend controls to the funding entity 110 or issuing institution 106 for implementation. For example, if the issuing institution 106 is determining compliance with spend controls during transaction processing, the issuing institution 106 may be informed (e.g., by the processing server 102 directly or by the funding entity 110) of the modifications to the spending controls for implementation thereof. In some cases, the processing server 102 may be a part of the issuing institution 106 and may implement the spend control modifications accordingly. In other embodiments, the processing server 102 may be configured to process spend controls for payment transactions. In such embodiments, the payment network 114 may provide transaction messages for payment transactions to the processing server 102, which may determine compliance with the applicable spend controls. Transaction messages for compliance transactions may then be forwarded on to the issuing institution 106, while transaction messages for non-compliant transactions may be declined directly by the processing server 102 on behalf of the issuing institution 106 or forwarded on to the issuing institution 106 with a recommendation that the transaction be declined. In embodiments where the payment network 114 may implement spend controls, the processing server 102 may inform the payment network 114 of modifications to the spend controls.

The methods and systems discussed herein thus enable a funding entity 110 to provide funding to a vast number of recipients 104 where funding is automatically adjusted depending on adherence of recipients 104 to funding rules without the funding entity 110 having to manually manage spend controls. The use of the processing server 102 for evaluating adherence to established rules can ensure that the funding entity 110 can focus on funding and simply adjust adherence rules in order to affect the overall usage of funds distributed to recipients 104. The processing server 102 operating as an external system to the funding entity 110 can also ensure that such implementations can occur with minimal modification to existing funding entity 110 systems, ensuring easier and more efficient adoption and implementation. The processing server 102 thus represents a technological improvement over systems for distributing and controlling funding of a plurality of recipients 104 for a funding entity 110 and use of the funds associated therewith.

Processing Server

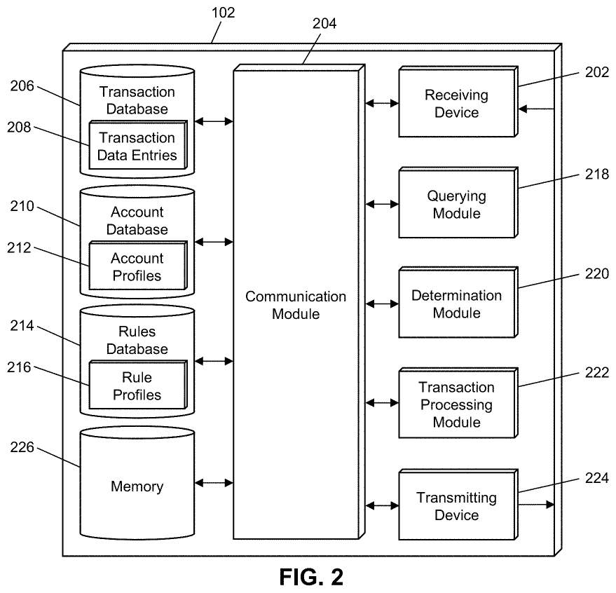

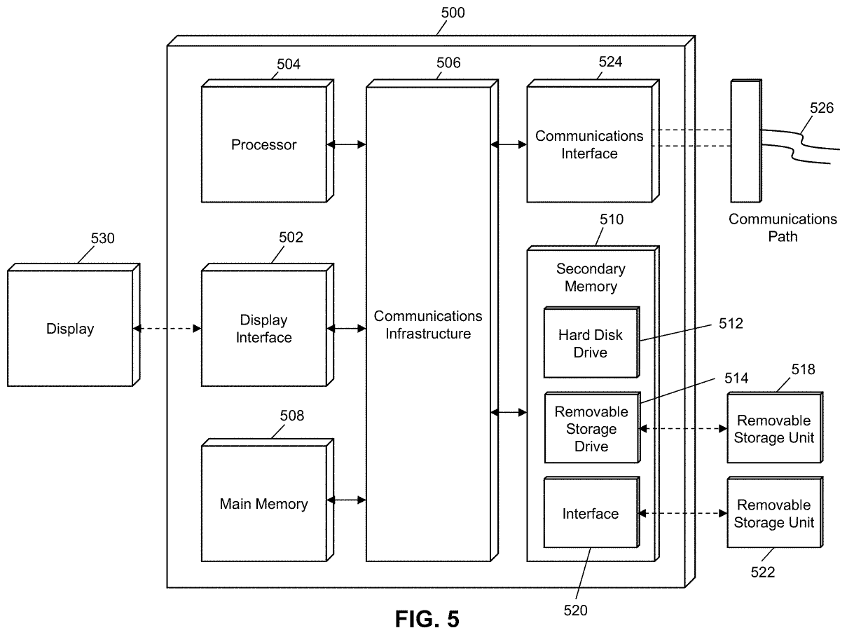

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from issuing institutions 106, funding entities 110, payment networks 114, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuing institutions 106, funding entities 110, and payment networks 114 that may be superimposed or otherwise encoded with transaction data for processed payment transactions, where the transaction data may include a CPN, transaction date, merchant category code, and any other suitable data for each payment transaction. In some embodiments, the receiving device 202 may also be configured to receive data signals electronically transmitted by payment networks 114 that are superimposed or otherwise encoded with transaction messages for payment transactions that are being processed, such as for evaluation of compliance with spend controls. The receiving device 202 may be further configured to receive data signals electronically transmitted by funding entities 110 that may be superimposed or otherwise encoded with adherence rules, funding rules, spend controls, and other rules or criteria that may be provided on a recipient- or CPN-specific basis, may be applicable to all recipients 104, or may be applicable to specified groups of recipients 104.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilizes various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, determination module 220, transaction processing module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a transaction database 206. The transaction database 206 may be configured to store a plurality of transaction data entries 208 using a suitable data storage format and schema. The transaction database 206 may be a relational database that utilizes structured query language for the storage, identification, modifying, updating, accessing, etc. of structured data sets stored therein. Each transaction profile 208 may be a structured data set configured to store data related to a payment transaction. Each transaction data entry 208 may include at least a CPN used to fund the payment transaction, a merchant category code, transaction date, and any other transaction data suitable for performing the functions discussed herein, such as a transaction amount, geographic location, transaction time, merchant identifier, product data, reward data, loyalty data, offer data, acquirer data, currency type, etc.

The processing server 102 may also include an account database 210. The account database 210 may be configured to store a plurality of account profiles 212 using a suitable data storage format and schema. The account database 210 may be a relational database that utilizes structured query language for the storage, identification, modifying, updating, accessing, etc. of structured data sets stored therein. Each account profile 212 may be a structured data set configured to store data related to a recipient 104 account. An account profile 212 may include, for instance, the CPN issued to the related recipient 104 and applicable spend controls. An account profile 212 may also include, in some embodiments, transaction history such as transaction data entries 208 and/or spend control data, such as aggregated transaction amount totals or other data used in determining compliance with spend controls.

The processing server 102 may also include a rules database 214. The rules database 214 may be configured to store a plurality of rules profiles 216 using a suitable data storage format and schema. The rules database 214 may be a relational database that utilizes structured query language for the storage, identification, modifying, updating, accessing, etc. of structured data sets stored therein. Each rules profile 216 may be a structured data set configured to store data related to an adherence rule or funding rule. The rule profile 216 may include the adherence rule or funding rule, such as including data values associated therewith (e.g., a merchant category code and associated spending amount for adherence rules, an adherence score and corresponding adjustment to spend controls for funding rules, etc.), as well as data indicating applicability of the related rule, such as CPNs or recipient categories to which the rule applies.

The processing server 102 may include a querying module 218. The querying module 218 may be configured to execute queries on databases to identify information. The querying module 218 may receive one or more data values or query strings, and may execute a query string based thereon on an indicated database, such as the transaction database 206, to identify information stored therein. The querying module 218 may then output the identified information to an appropriate engine or module of the processing server 102 as necessary. The querying module 218 may, for example, execute a query on the transaction database 206 to identify a plurality of transaction data entries 208 related to payment transactions conducted by a recipient 104 for use in evaluating adherence to one or more adherence rules.

The processing server 102 may also include a determination module 220. The determination module 220 may be configured to make determinations for the processing server 102 for use in performing the functions discussed herein. The determination module 220 may receive instructions as input, may make a determination based on the instructions, and may output the determination to one or more modules of the processing server 102. In some cases, the input may include data and/or rules to be used in the determination. In other cases, the determination module 220 may be configured to identify such data based on the instructions. For example, the determination module 220 may be configured to determine an adherence score for a recipient 104 (e.g., or a CPN or account profile 212 associated therewith) based on one or more adherence rules (e.g., identified in corresponding rule profiles 216) as applied to transaction data entries 208 identified for the recipient 104.

In some embodiments, the processing server 102 may also include a transaction processing module 222. The transaction processing module 222 may be configured to perform functions related to the processing of electronic payment transactions. For instance, the transaction processing module 222 may be configured to determine compliance or non-compliance of a payment transaction with spend controls, determine approval or denial of a payment transaction as or on behalf of an issuing institution 106, generate authorization request or response messages, receive and transmit transaction messages using payment rails associated with a payment network 114, etc.

The processing server 102 may also include a transmitting device 224. The transmitting device 224 may be configured to transmit data over one or more networks via one or more network protocols. In some instances, the transmitting device 224 may be configured to transmit data to issuing institutions 106, funding entities 110, payment networks 114, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to issuing institutions 106, funding entities 110, and payment networks 114 that are superimposed or otherwise encoded with requests for transaction data, which may include a CPN and any other criteria for which payment transaction data is requested. The transmitting device 224 may also be configured to electronically transmit data signals to issuing institutions 106, funding entities 110, and payment networks 114, as applicable, that may be superimposed or otherwise encoded with adherence scores and/or spend control modifications.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, transaction processing rules, transaction message formatting standards, spend control rules and algorithms, transaction message routing data, etc.

Process for Modification of Spending Controls Based on Adherence

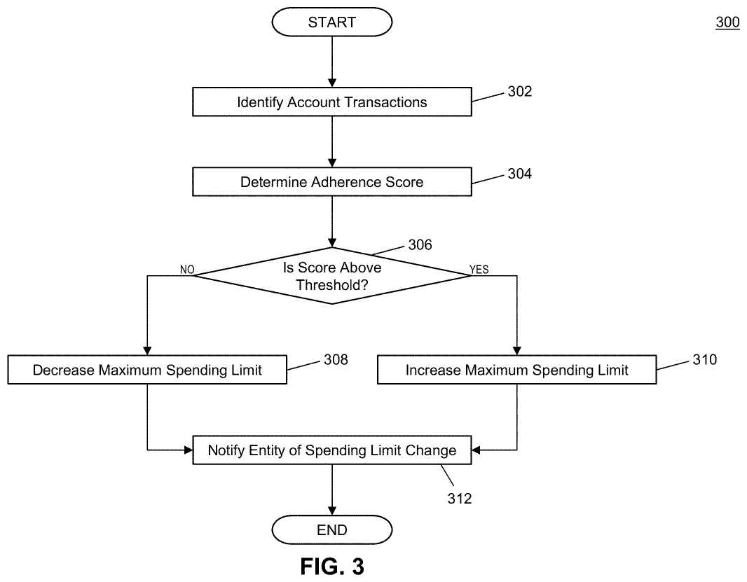

FIG. 3 illustrates an example process 300 for the modification to spending controls for a CPN based on adherence of usage of the CPN with one or more applicable adherence controls related to the funding of the CPN as executed by the processing server 102 in the system 100.

In step 302, the querying module 218 of the processing server 102 may execute a query on the transaction database 206 of the processing server 102 to identify a plurality of transaction data entries 208 related to a recipient 104, where each of the transaction data entries includes the CPN related to the recipient 104. In step 304, the determination module 220 of the processing server 102 may determine an adherence score for the recipient 104. Determination of the adherence score may include the execution of one or more queries by the querying module 218 on the transaction database 206 to identify, of the identified plurality of transaction data entries 208, one or more subsets of transaction data entries 208 where each transaction data entry 208 in a subset has transaction data that matches an applicable adherence rule. Applicable adherence rules may be identified via the querying, by the querying module 218, of the rules database 214 to identify rule profiles 216 that include the recipient's CPN or otherwise indicate applicability thereto. The determination module 220 of the processing server 102 may use the subset(s) of transaction data entries 208 to determine adherence to the applicable adherence rule(s) as compared to the overall identified plurality of transaction data entries 208 and data included therein.

Once the adherence score has been identified, then, in step 306, the determination module 220 may determine if the adherence score is above a threshold applicable to the recipient 104. Such a threshold may be set by the funding entity 110 and/or may be identified in an account profile 212 associated with the recipient 104 or a funding rule identified in a rule profile 216 of the rules database 214. If the adherence score is not above the threshold, then, in step 308, the querying module 218 of the processing server 102 may execute a query on the account profile 212 related to the recipient 104 to decrease the maximum spending limit for the CPN. In some cases, the amount of the decrease may be based on the adherence score and/or the funding rule. If, in step 306, the determination module 220 determines that the adherence score is above the threshold, then, in step 310, a query may be executed on the account database 210 to increase the maximum spending limit for the CPN in the account profile 212, where such an increase may be based on the adherence score and/or funding rule.

In step 312, the transmitting device 224 of the processing server 102 may electronically transmit a notification to the recipient 104 indicating that their maximum spending limit was adjusted. In some cases, the notification may indicate the amount of the adjustment. In some instance, the notification may indicate why the amount was adjusted, such as including the adherence score, funding rule, adherence rule, or report based thereon. The notification may be electronically transmitted to a computing device associated with the recipient 104 using any suitable communication network and method, such as short messaging service message, multimedia messaging service message, e-mail, a webpage, an application program, etc. In some cases, the notification may be electronically transmitted to the funding entity 110 or issuing institution 106 for forwarding to the recipient 104. In other cases, the funding entity 110 or issuing institution 106 may provide the processing server 102 with communication data for use in transmitting the notification to the recipient 104.

Exemplary Method for Evaluating Adherence to Funding Rules

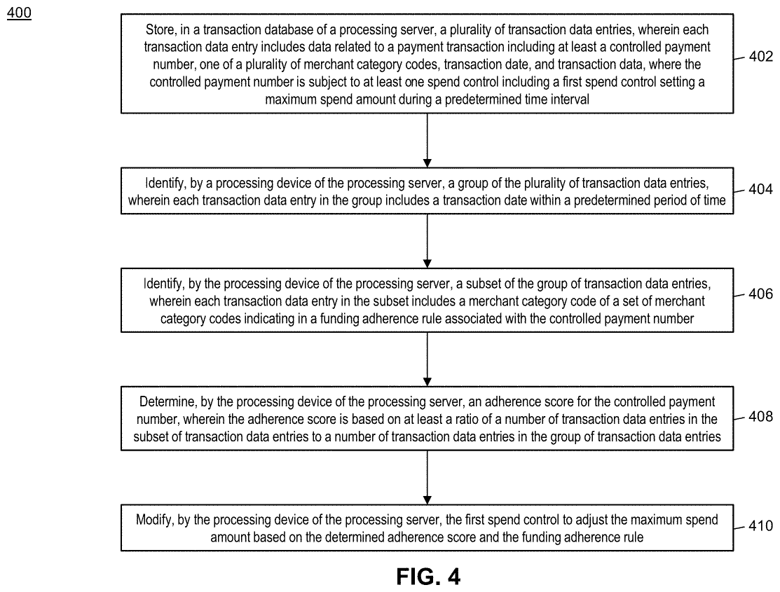

FIG. 4 illustrates a method 400 for evaluating adherence to funding rules in the use of a controlled payment number for a series of electronic payment transactions and adjustment of applicable spend controls based thereon.

In step 402, a plurality of transaction data entries (e.g., transaction data entries 208) may be stored in a transaction database (e.g., the transaction database 206) of a processing server (e.g., the processing server 102), wherein each transaction data entry includes data related to a payment transaction including at least a controlled payment number, one of a plurality of merchant category codes, transaction date, and transaction data, where the controlled payment number is subject to at least one spend control including a first spend control setting a maximum spend amount during a predetermined time interval. In step 404, a group of the plurality of transaction data entries may be identified by a processing device of the processing server, wherein each transaction data entry in the group includes a transaction date within a predetermined period of time.

In step 406, a subset of the group of transaction data entries may be identified by the processing device of the processing server, wherein each transaction data entry in the subset includes a merchant category code of a set of merchant category codes indicated in a funding adherence rule associated with the controlled payment number. In step 408, an adherence score for the controlled payment number may be determined by the processing device of the processing server, wherein the adherence score is based on at least a ratio of a number of transaction data entries in the subset of transaction data entries to a number of transaction data entries in the group of transaction data entries. In step 410, the first spend control may be modified by the processing device of the processing server to adjust the maximum spend amount based on the determined adherence score and the funding adherence rule.

In one embodiment, the method 400 may further include storing, in an account database (e.g., the account database 210) of the processing server, an account profile (e.g., an account profile 212), wherein the account profile includes data related to a user account including at least the controlled payment number and the first spend control. In a further embodiment, the account profile may further include the funding adherence rule. In some embodiments, the method 400 may also include storing, in a rules database (e.g., the rules database 214) of the processing server, a plurality of rule profiles (e.g., rule profiles 216), wherein each rule profile includes at least an adherence rule and one or more account identifiers, the funding adherence rule is the adherence rule included in a specific rule profile, and the one or more account identifiers included in the specific rule profile includes an account identifier corresponding to the controlled payment number.

In one embodiment, the method 400 may further include: receiving, by a receiver (e.g., the receiving device 202) of the processing server, a spend control request, wherein the spend control request includes at least data identifying the controlled payment number; and transmitting, by a transmitter (e.g., the transmitting device 224) of the processing server, the modified first spend control in response to the spend control request. In a further embodiment, the spend control request may further include the predetermined period of time. In another further embodiment, the spend control request may further include the funding adherence rule. In some embodiments, the funding adherence rule may include a threshold value, the maximum spend amount may be increased if the adherence score is above the threshold value, and the maximum spend amount may be decreased if the adherence score is below the threshold value.

Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3 and 4, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for evaluating adherence to funding rules. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for evaluating adherence to funding rules, comprising:
storing, in a transaction database of a processing server, a plurality of transaction data entries, wherein each transaction data entry includes data related to a payment transaction including at least a controlled payment number, one of a plurality of merchant category codes, transaction date, and transaction data, where the controlled payment number is subject to at least one spend control including a first spend control setting a maximum spend amount during a predetermined time interval;
identifying, by a processing device of the processing server, a group of the plurality of transaction data entries, wherein each transaction data entry in the group includes a transaction date within a predetermined period of time;
identifying, by the processing device of the processing server, a subset of the group of transaction data entries, wherein each transaction data entry in the subset includes a merchant category code of a set of merchant category codes indicated in a funding adherence rule associated with the controlled payment number;
determining, by the processing device of the processing server, an adherence score for the controlled payment number, wherein the adherence score is based on at least a ratio of a number of transaction data entries in the subset of transaction data entries to a number of transaction data entries in the group of transaction data entries; and
modifying, by the processing device of the processing server, the first spend control to adjust the maximum spend amount based on the determined adherence score and the funding adherence rule.

2. The method of claim 1, further comprising:
storing, in an account database of the processing server, an account profile, wherein the account profile includes data related to a user account including at least the controlled payment number and the first spend control.

3. The method of claim 2, wherein the account profile further includes the funding adherence rule.

4. The method of claim 1, further comprising:
storing, in a rules database of the processing server, a plurality of rule profiles, wherein each rule profile includes at least an adherence rule and one or more account identifiers, wherein
the funding adherence rule is the adherence rule included in a specific rule profile, and
the one or more account identifiers included in the specific rule profile includes an account identifier corresponding to the controlled payment number.

5. The method of claim 1, further comprising:
receiving, by a receiver of the processing server, a spend control request, wherein the spend control request includes at least data identifying the controlled payment number; and
transmitting, by a transmitter of the processing server, the modified first spend control in response to the spend control request.

6. The method of claim 5, wherein the spend control request further includes the predetermined period of time.

7. The method of claim 5, wherein the spend control request further includes the funding adherence rule.

8. The method of claim 1, wherein
the funding adherence rule includes a threshold value,
the maximum spend amount is increased if the adherence score is above the threshold value; and
the maximum spend amount is decreased if the adherence score is below the threshold value.

9. A system for evaluating adherence to funding rules, comprising:
a transaction database of a processing server configured to store a plurality of transaction data entries, wherein each transaction data entry includes data related to a payment transaction including at least a controlled payment number, one of a plurality of merchant category codes, transaction date, and transaction data, where the controlled payment number is subject to at least one spend control including a first spend control setting a maximum spend amount during a predetermined time interval; and
a processing device of the processing server configured to
identify a group of the plurality of transaction data entries, wherein each transaction data entry in the group includes a transaction date within a predetermined period of time,
identify a subset of the group of transaction data entries, wherein each transaction data entry in the subset includes a merchant category code of a set of merchant category codes indicated in a funding adherence rule associated with the controlled payment number,
determine an adherence score for the controlled payment number, wherein the adherence score is based on at least a ratio of a number of transaction data entries in the subset of transaction data entries to a number of transaction data entries in the group of transaction data entries, and
modify the first spend control to adjust the maximum spend amount based on the determined adherence score and the funding adherence rule.

10. The system of claim 9, further comprising:
an account database of the processing server configured to store an account profile, wherein the account profile includes data related to a user account including at least the controlled payment number and the first spend control.

11. The system of claim 10, wherein the account profile further includes the funding adherence rule.

12. The system of claim 9, further comprising:
a rules database of the processing server configured to store a plurality of rule profiles, wherein each rule profile includes at least an adherence rule and one or more account identifiers, wherein
the funding adherence rule is the adherence rule included in a specific rule profile, and
the one or more account identifiers included in the specific rule profile includes an account identifier corresponding to the controlled payment number.

13. The system of claim 9, further comprising:
a receiver of the processing server configured to receive a spend control request, wherein the spend control request includes at least data identifying the controlled payment number; and
a transmitter of the processing server configured to electronically transmit the modified first spend control in response to the spend control request.

14. The system of claim 13, wherein the spend control request further includes the predetermined period of time.

15. The system of claim 13, wherein the spend control request further includes the funding adherence rule.

16. The system of claim 9, wherein
the funding adherence rule includes a threshold value,
the maximum spend amount is increased if the adherence score is above the threshold value; and
the maximum spend amount is decreased if the adherence score is below the threshold value.
